(19) United States
(12) Patent Application Publication
(10) Pub. No.: US 2026/0153835 A1
(43) Pub. Date: Jun. 4, 2026

(54) METHOD FOR PREPARING POLARIZATION VOLUME HOLOGRAPHIC GRATING CAPABLE OF ACHIEVING DIFFERENT DIFFRACTION EFFICIENCIES, AND POLARIZATION VOLUME HOLOGRAPHIC GRATING

(71) Applicant: SOUTHEAST UNIVERSITY, Nanjing (CN)

(72) Inventors: Nan LIN, Nanjing (CN); Yuning Zhang, Nanjing (CN); Yishi Weng, Nanjing (CN); Chuang Wang, Nanjing (CN); Yuchen Gu, Nanjing (CN); Ran Wei, Nanjing (CN)

(73) Assignee: SOUTHEAST UNIVERSITY, Nanjing (CN)

(21) Appl. No.: 19/460,351

(22) Filed: Jan. 27, 2026

Related U.S. Application Data
(63) Continuation of application No. PCT/CN2025/096714, filed on May 23, 2025.

(30) Foreign Application Priority Data
Jun. 28, 2024 (CN) 202410857722.2

(51) Int. Cl. G03H 1/02; G02F 1/1337

(52) U.S. Cl. CPC G03H 1/0248; G02F 1/133788; G03H 2240/15; G03H 2240/53; G03H 2250/38

(57) ABSTRACT

A method for preparing a polarization volume holographic grating capable of achieving different diffraction efficiencies includes: coating a top surface of a substrate medium with a photo-alignment layer; covering a top surface of the photo-alignment layer with a mask, and performing interference exposure using two orthogonal circularly-polarized beams; removing the mask, and then coating the top surface of the photo-alignment layer with a layer of liquid crystal solution of a preset concentration; placing the liquid crystal solution into a nitrogen environment, and curing the liquid crystal solution under UV irradiation to obtain a liquid crystal film; removing a disordered liquid crystal film in a non-grating region on the substrate medium using a laser cleaning device, so as to obtain a PVG; and covering a surface of the PVG with a graded-UV-transmittance filter, and exposing the grating through the filter to UV light to obtain PVG regions.

### CROSS REFERENCE TO THE RELATED APPLICATIONS

This application is the continuation application of International Application No. PCT/CN2025/096714, filed on May 23, 2025, which is based upon and claims priority to Chinese Patent Application No. 202410857722.2, filed on Jun. 28, 2024, the entire contents of which are incorporated herein by reference.

### TECHNICAL FIELD

This application relates to the technical field of optical elements, and in particular, to a method for preparing a polarization volume holographic grating capable of achieving different diffraction efficiencies, and a polarization volume holographic grating.

### BACKGROUND

Exit-pupil expansion is one of the most prominent features and advantages of a diffractive optical waveguide system. Light propagates within the waveguide medium under conditions of total internal reflection, thereby achieving low-loss propagation in the waveguide medium. In an out-coupling grating region, due to limitations on grating diffraction efficiency, the out-coupling grating can diffract only a part of optical energy each time while the remaining optical energy continues to propagate along the waveguide. Through continuous propagation and repeated diffraction, the light is continuously replicated and coupled out of the waveguide, thereby implementing an expanded exit pupil. As the light is continuously replicated and coupled at the out-coupling grating, the remaining optical energy progressively decreases, and the brightness of the out-coupled light correspondingly decreases, thereby affecting the brightness uniformity over the imaging field-of-view. Therefore, incorporating grating diffraction efficiency modulation into the design of an exit-pupil expansion scheme is an essential technical means.

Currently, the technical solution to diffraction efficiency modulation of a polarization volume holographic grating is mainly implemented by controlling the thickness of a grating medium layer. During the preparation of a polarization volume holographic grating, the thickness of the grating medium layer is closely related to a coating method employed. Mainstream coating methods include spin coating, blade coating, and inkjet printing. Spin coating and blade coating require relatively low equipment costs, but are incapable of achieving patterned control of a liquid-crystal layer, and an obvious boundary line is generated at the interface of coating passes in adjacent regions, thereby disrupting the integrity of the grating. Inkjet printing requires extremely high equipment costs, and, as affected by a thickness modulation scheme employed, a height difference occurs between the grating medium layers of different regions during patterned diffraction-efficiency control. During subsequent waveguide bonding and packaging, the height difference is prone to cause bumpiness, collapse or other problems of the waveguide medium, thereby resulting in severe imaging artifacts such as ghosting, color bifurcation, and jelly-like image distortion. Therefore, it is vital to invent a technical solution that can achieve cost-effective patterned modulation of diffraction efficiency of polarization volume holographic gratings while ensuring uniform grating thickness.

### SUMMARY

An objective of this application is to overcome the defects of the prior art and provide a method for preparing a polarization volume holographic grating capable of achieving different diffraction efficiencies, and a polarization volume holographic grating.

To achieve the above objective, this application puts forward the following technical solutions:

According to a first aspect, this application provides a method for preparing a polarization volume holographic grating capable of achieving different diffraction efficiencies. The method includes:
step 1: coating a top surface of a substrate medium with a photo-alignment layer;
step 2: covering a top surface of the photo-alignment layer with a mask, and performing interference exposure using two orthogonal circularly-polarized beams;
step 3: removing the mask after completion of the exposure, and then coating the top surface of the photo-alignment layer with a layer of liquid crystal solution of a preset concentration, where the liquid crystal solution is used for preparing a grating medium layer and is 100 nm to 10 μm in thickness;
step 4: placing the substrate medium covered with the liquid crystal solution into a nitrogen environment, and curing the liquid crystal solution under ultraviolet (UV) irradiation to obtain a liquid crystal film;
step 5: removing a disordered liquid crystal film in a non-grating region on the substrate medium using a laser cleaning device, so as to obtain a PVG; and
step 6: covering a surface of the PVG with a graded-UV-transmittance filter, and exposing the grating through the filter to UV light to obtain PVG regions in which a grating medium thickness is uniform and diffraction efficiencies vary continuously and increase progressively.

Further, the substrate medium is made of optical glass or resin glass and is a flat plate or a freeform body in shape. A thickness of the grating medium layer is set to satisfy a requirement for a maximum diffraction efficiency of the grating in a waveguide scheme.

Further, the mask is a hollowed-out light-shielding sheet.

Further, the liquid crystal solution with a preset concentration is a liquid crystal solution with a concentration of 1% to 50%. The liquid crystal solution with a preset concentration includes a chiral agent, liquid crystal, an acrylate-based polymerizable monomer, a photoinitiator, and a surfactant.

Further, in step 4, the prepared grating medium layer is placed in a nitrogen environment and cured under irradiation of UV light of 10 nm to 400 nm.

Further, the filter is a neutral-density filter. The filter includes a plurality of regions. Each region exhibits a different UV transmittance. UV transmittances of the regions are set from low to high sequentially with a fixed step value.

Further, the filter is a wedge-shaped filter capable of partially absorbing UV light.

Further, in step 6, the neutral-density filter is subjected to exposure to UV light of 10 nm to 400 nm for a preset time to obtain a plurality of PVG regions in which the grating medium thickness is uniform and the diffraction efficiencies increase progressively.

Further, in step 6, wedge-shaped optical glass is exposed to UV light of 10 nm to 400 nm for a preset time to obtain a PVG region in which the grating medium thickness is uniform and the diffraction efficiencies are distributed in a graded manner.

According to a second aspect, this application provides a polarization volume holographic grating. The grating is prepared using the preparation method disclosed above.

This application achieves at least the following beneficial effects:
1. The preparation method is simple and the equipment cost is low. The equipment required by this method can directly use the UV light source employed in the UV curing step in the grating preparation process, without the need for additional equipment.
2. By reducing the diffraction efficiency of the polarization volume holographic grating by means of exposure, this method can simply and effectively implement patterned or graded modulation of diffraction efficiencies, thereby ensuring the continuity and integrity of the grating.
3. This method ensures uniformity of the thickness of the grating medium layer, thereby significantly simplifying the subsequent waveguide bonding and packaging operations, and reducing the risk of severe imaging artifacts such as ghosting, color bifurcation, and jelly-like image distortions.

### BRIEF DESCRIPTION OF THE DRAWINGS

FIG. 1 is a schematic flowchart of a preparation method according to this application;

FIG. 2 is a schematic structural diagram of a polarization volume holographic grating;

FIG. 3 is a schematic diagram of a polarization volume holographic grating capable of achieving different diffraction efficiencies and prepared using the preparation method disclosed in Embodiment 1; and

FIG. 4 is a schematic diagram of a polarization volume holographic grating capable of achieving different diffraction efficiencies and prepared using the preparation method disclosed in Embodiment 2.

List of reference signs: 1. substrate medium; 2. neutral-density filter; 3. wedge-shaped optical glass; 4. photo-alignment layer; 5. mask; 6. in-coupling grating; 7. out-coupling grating.

### DETAILED DESCRIPTION OF THE EMBODIMENTS

The following describes this application in further detail with reference to accompanying drawings. The following embodiments are merely intended to describe the technical solutions of this application more clearly, but not intended to limit the protection scope of this application.

### Embodiment 1

This application is mainly applicable to polarization volume gratings (PVGs). The high diffraction efficiency of a PVG is primarily attributed to a periodic anisotropic refractive index distribution generated within the grating by a longitudinal liquid crystal structure of the grating, which satisfies the Bragg volume diffraction condition. For a perpendicularly incident beam, the Bragg condition of the PVG may be expressed by the following formula:

$$2 {n}_{eff} {Λ}_{B} cos φ = {λ}_{B}$$

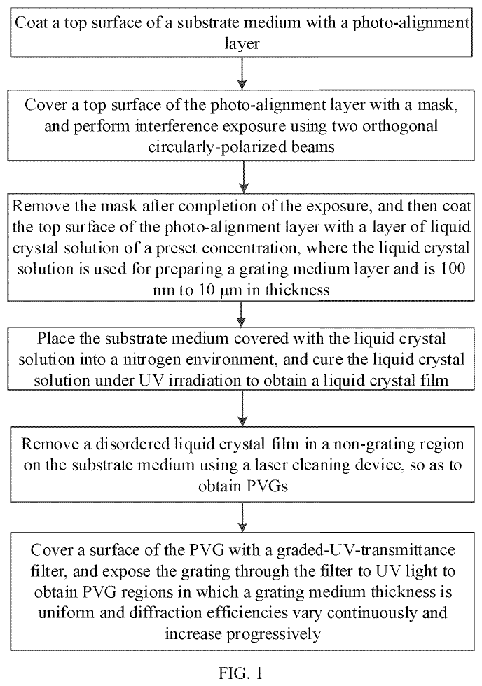

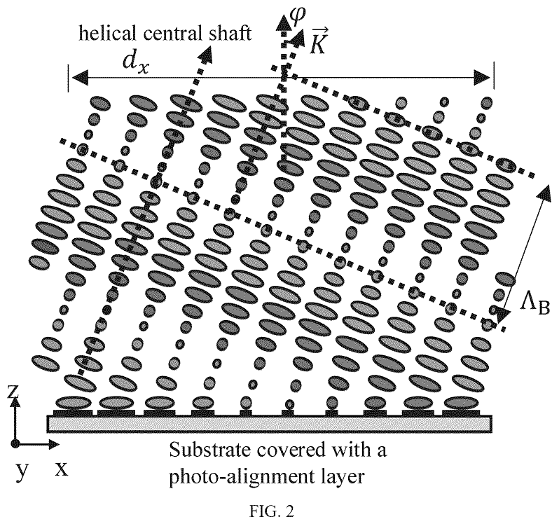

In the formula above, λ_{B} is a Bragg wavelength in vacuum, Λ_{B} is a Bragg period, φ is a tilt angle of equal-refractive-index planes or, equivalently, a tilt angle represented by a grating vector K, as shown in FIG. 1; and n_{eff} is an average refractive index of the anisotropic medium, which may be defined as:

$${n}_{eff} = \sqrt{( {n}_{e}^{2} + 2 {n}_{o}^{2} / 3 )}$$

To achieve highly efficient Bragg diffraction, along the longitudinal direction of the PVG medium, a sufficient number of refractive-index variation periods is required to implement superposition of interlayer reflections from the refractive-index planes. A larger number of Bragg diffraction periods contained in the internal structure of the PVG leads to a larger amount of optical energy that can be diffracted with the superimposition of interlayer reflections. The contrary leads to a lower diffraction efficiency. Therefore, when it is ensured that the thickness of the liquid crystal layers of the PVG is uniform, without considering the diffraction angle and the Bragg wavelength variations, we can modulate the diffraction efficiency of the PVG by changing the number of Bragg periods within the PVG. UV light exposure can help change the optical properties of liquid crystal molecules and reduce the refractive index modulation depth Δn of the liquid crystal molecules, thereby increasing the Bragg period. When the thickness remains uniform, this reduces the number of Bragg periods contained within the PVG medium, thereby achieving a decline in the diffraction efficiency of the PVG. By means of UV exposure, patterned control or even graded control on the diffraction efficiency can be conveniently implemented.

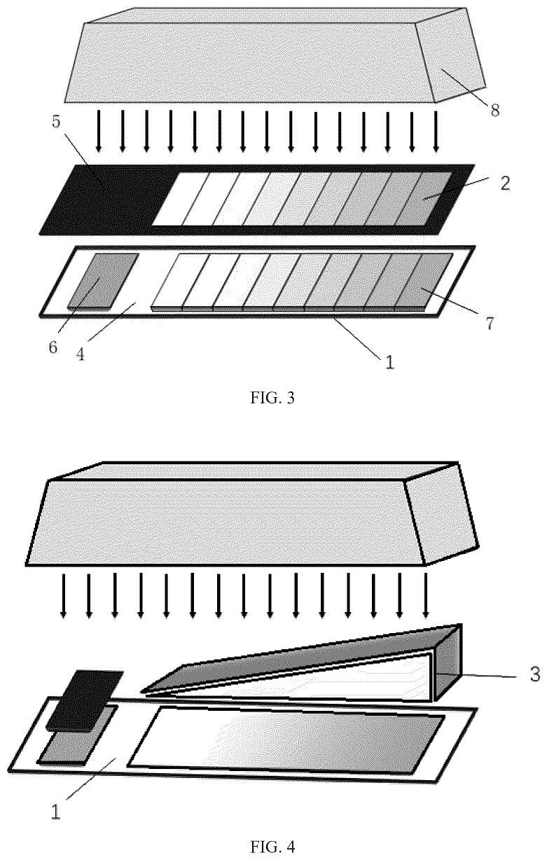

Specifically, this embodiment describes a method for preparing a polarization volume holographic grating capable of achieving different diffraction efficiencies. As shown in FIG. 1 and FIG. 3, the method includes the following steps:
Step 1: Coat a top surface of a substrate medium 1 with a photo-alignment layer 4.
Step 2: Cover a top surface of the photo-alignment layer 4 with a mask 5 (the mask 5 is a hollowed-out light-shielding sheet, the covered part is opaque, and the center is hollow, and the hollowed-out region forms a lateral grating structure under laser exposure), and perform interference exposure using two orthogonal circularly-polarized beams.
Step 3: Remove the mask 5 after completion of the exposure, and then coat the top surface of the photo-alignment layer 4 with a layer of liquid crystal solution of a preset concentration, where the liquid crystal solution is used for preparing a grating medium layer and is 5 μm in thickness.
Step 4: Place the liquid crystal solution into a nitrogen environment, and cure the liquid crystal solution under UV irradiation to obtain a liquid crystal film.
Step 5: Remove a disordered liquid crystal film in a non-grating region on the substrate medium using a laser cleaning device, so as to obtain PVGs (an in-coupling grating 6 and an out-coupling grating with uniform diffraction efficiency).
Step 6: Cover a surface of the PVG with a graded-UV-transmittance filter, and expose the grating through the filter to UV light to obtain PVG regions in which a grating medium thickness is uniform and diffraction efficiencies vary continuously and increase progressively, where the PVG regions constitute the out-coupling grating 7.

The polarization volume holographic grating is prepared on an optical medium that exhibits a specified refractive index and a specified transmittance, with the refractive index ranging from 1.5 to 2.2. The substrate medium is made of optical glass or resin glass, and is a flat plate or a freeform body in shape.

The thickness of the grating medium layer may be controlled to fall within 100 nm to 10 μm. The thicker the grating medium layer, the higher the grating diffraction efficiency. Choosing an appropriate thickness can satisfy the requirement for a maximum diffraction efficiency of the grating in the waveguide scheme.

The liquid crystal solution with a preset concentration is a liquid crystal solution with a concentration of 1% to 50% (in this embodiment, a liquid crystal solution with a concentration of 38% is adopted). The liquid crystal solution with a preset concentration includes a chiral agent, liquid crystal, an acrylate-based polymerizable monomer, a photoinitiator, and a surfactant. The refractive index modulation depth of the liquid crystal composition and the acrylate-based polymerizable monomer material used is preferably as high as practicable. Currently, the refractive index modulation depth of commonly used materials is 0.1 to 0.3.

For the UV exposure, the wavelength of the UV light used may be any wavelength band within the range of 10 nm to 400 nm. The higher the UV light intensity (energy), the shorter the exposure time required. Regional control of diffraction efficiency can be implemented by controlling the UV light intensity within the same exposure time, or the diffraction efficiency of the grating sample can be reduced to a target value by controlling the exposure duration under the same UV light intensity.

In this embodiment, the filter is a neutral-density filter 2. The neutral-density filter 2 is formed of nine parts (the number of parts may be adjusted as required; in this embodiment, the filter includes nine parts). The UV transmittance of each region is controlled to be different, with a minimum transmittance being 10%. The UV transmittance of each region is set in increments of 10%, with a maximum transmittance being 90%. Exposure is performed under 365 nm UV light for 8 hours, with the UV energy density controlled at 20 J/cm², thereby obtaining nine PVG regions in which the grating medium thickness is uniform and the diffraction efficiencies vary continuously and increase progressively.

### Embodiment 2

As shown in FIG. 4, this embodiment differs from Embodiment 1 in that the filter is wedge-shaped optical glass 3. Optical glass itself exhibits a degree of resistance to transmission of UV light. By controlling the thickness of the optical glass, the transmittance of the UV light can be controlled. Accordingly, the optical glass is formed into a wedge shape, such that the intensity of UV light transmitted through the optical glass exhibits a graded gradient distribution. Similarly, the exposure is performed under 365 nm UV light for 8 hours, with the UV energy density controlled at 20 J/cm², thereby obtaining one PVG region in which the grating medium thickness is uniform and the diffraction efficiencies are distributed in a graded manner.

### Embodiment 3

Based on the same inventive concept as Embodiment 1 or Embodiment 2, this embodiment discloses a polarization volume holographic grating that is prepared using the preparation method disclosed in Embodiment 1 or Embodiment 2.

The foregoing descriptions are merely preferred embodiments of this application. It is noted that various improvements and variations, which may be made by a person of ordinary skill in the art without departing from the technical principles of this application, shall still fall within the protection scope of this application.

What is claimed is:

1. A method for preparing a polarization volume holographic grating capable of achieving different diffraction efficiencies, comprising:
step 1: coating a top surface of a substrate medium with a photo-alignment layer;
step 2: covering a top surface of the photo-alignment layer with a mask, and performing interference exposure using two orthogonal circularly-polarized beams;
step 3: removing the mask after completion of the exposure, and then coating the top surface of the photo-alignment layer with a layer of liquid crystal solution of a preset concentration, wherein the liquid crystal solution is used for preparing a grating medium layer and is 100 nm to 10 μm in thickness;
step 4: placing the substrate medium covered with the liquid crystal solution into a nitrogen environment, and curing the liquid crystal solution under ultraviolet (UV) irradiation to obtain a liquid crystal film;
step 5: removing a disordered liquid crystal film in a non-grating region on the substrate medium using a laser cleaning device, so as to obtain a polarization volume grating (PVG); and
step 6: covering a surface of the PVG with a graded-UV-transmittance filter, and exposing the grating through the filter to UV light to obtain PVG regions in which a grating medium thickness is uniform and diffraction efficiencies vary continuously and increase progressively.

2. The method for preparing the polarization volume holographic grating capable of achieving different diffraction efficiencies according to claim 1, wherein the substrate medium is made of optical glass or resin glass and is a flat plate or a freeform body in shape; and a thickness of the grating medium layer is set to satisfy a requirement for a maximum diffraction efficiency of the grating in a waveguide scheme.

3. The method for preparing the polarization volume holographic grating capable of achieving different diffraction efficiencies according to claim 1, wherein the mask is a hollowed-out light-shielding sheet.

4. The method for preparing the polarization volume holographic grating capable of achieving different diffraction efficiencies according to claim 1, wherein the liquid crystal solution with the preset concentration is a liquid crystal solution with a concentration of 1% to 50%; and the liquid crystal solution with the preset concentration comprises a chiral agent, liquid crystal, an acrylate-based polymerizable monomer, a photoinitiator, and a surfactant.

5. The method for preparing the polarization volume holographic grating capable of achieving different diffraction efficiencies according to claim 1, wherein in step 4, the prepared grating medium layer is placed in the nitrogen environment and cured under irradiation of UV light of 10 nm to 400 nm.

6. The method for preparing the polarization volume holographic grating capable of achieving different diffraction efficiencies according to claim 1, wherein the filter is a neutral-density filter, the filter comprises a plurality of regions, each region exhibits a different UV transmittance, and UV transmittances of the regions are set from low to high sequentially with a fixed step value.

7. The method for preparing the polarization volume holographic grating capable of achieving different diffraction efficiencies according to claim 1, wherein the filter is a wedge-shaped filter capable of partially absorbing UV light.

8. The method for preparing the polarization volume holographic grating capable of achieving different diffraction efficiencies according to claim 6, wherein in step 6, the neutral-density filter is subjected to exposure to UV light of 10 nm to 400 nm for a preset time to obtain a plurality of PVG regions in which the grating medium thickness is uniform and the diffraction efficiencies increase progressively.

9. The method for preparing the polarization volume holographic grating capable of achieving different diffraction efficiencies according to claim 7, wherein in step 6, wedge-shaped optical glass is exposed to UV light of 10 nm to 400 nm for a preset time to obtain a PVG region in which the grating medium thickness is uniform and the diffraction efficiencies are distributed in a graded manner.

10. A polarization volume holographic grating, prepared by the method according to claim 1.

11. The polarization volume holographic grating according to claim 10, wherein in the method, the substrate medium is made of optical glass or resin glass and is a flat plate or a freeform body in shape; and a thickness of the grating medium layer is set to satisfy a requirement for a maximum diffraction efficiency of the grating in a waveguide scheme.

12. The polarization volume holographic grating according to claim 10, wherein in the method, the mask is a hollowed-out light-shielding sheet.

13. The polarization volume holographic grating according to claim 10, wherein in the method, the liquid crystal solution with the preset concentration is a liquid crystal solution with a concentration of 1% to 50%; and the liquid crystal solution with the preset concentration comprises a chiral agent, liquid crystal, an acrylate-based polymerizable monomer, a photoinitiator, and a surfactant.

14. The polarization volume holographic grating according to claim 10, wherein in step 4 of the method, the prepared grating medium layer is placed in the nitrogen environment and cured under irradiation of UV light of 10 nm to 400 nm.

15. The polarization volume holographic grating according to claim 10, wherein in the method, the filter is a neutral-density filter, the filter comprises a plurality of regions, each region exhibits a different UV transmittance, and UV transmittances of the regions are set from low to high sequentially with a fixed step value.

16. The polarization volume holographic grating according to claim 10, wherein in the method, the filter is a wedge-shaped filter capable of partially absorbing UV light.

17. The polarization volume holographic grating according to claim 15, wherein in step 6 of the method, the neutral-density filter is subjected to exposure to UV light of 10 nm to 400 nm for a preset time to obtain a plurality of PVG regions in which the grating medium thickness is uniform and the diffraction efficiencies increase progressively.

18. The polarization volume holographic grating according to claim 16, wherein in step 6 of the method, wedge-shaped optical glass is exposed to UV light of 10 nm to 400 nm for a preset time to obtain a PVG region in which the grating medium thickness is uniform and the diffraction efficiencies are distributed in a graded manner.
